(19) United States
(12) Patent Application Publication
(10) Pub. No.: US 2007/0197363 A1
(43) Pub. Date: Aug. 23, 2007

(54) Polylactic acid based containers and methods of making the same

(76) Inventors: Michael A. Parrotta, Emmaus, PA (US); Robert L. Flowers, Coatesville, PA (US)

Correspondence Address: MEADWESTVACO CORPORATION;ALEXANDRA B. URBAN,ESQ., 299 PARK AVENUE, 13TH FLOOR, NEW YORK, NY, 10171, US

(21) Appl. No.: 11/595,207

(22) Filed: Nov. 10, 2006

Related U.S. Application Data
(60) Provisional application No. 60/735,931, filed on Nov. 10, 2005.
(60) Provisional application No. 60/790,623, filed on Apr. 10, 2006.

(51) Int. Cl. B31B 1/00

(52) U.S. Cl. 493/68

(57) ABSTRACT

A process for forming a container blank with flexible fold lines from polylactic acid sheet material. In the process, a sheet of polylactic acid material suitable for use as a container blank is placed between a forming tool and a substantially flat surface. The temperature of the forming tool is maintained at a point between the softening temperature and the melting temperature of the polylactic acid sheet. Then, a high frequency electric field is created between the forming tool and the flat surface so as to heat a portion of the polylactic acid sheet sandwiched therebetween, while pressing the forming tool into the sheet to a depth of at least 25% of the thickness of the sheet and forming bulges in the sheet adjacent to opposite sides of the tool. Next, the polylactic acid sheet is allowed to cool while maintaining the same in a substantially flat condition. Thereafter, a container is formed using the creased polylactic acid sheet.

### CROSS REFERENCE TO RELATED APPLICATIONS

This application claims priority to U.S. Provisional Patent Application Ser. No. 60/735,931, filed Nov. 10, 2005, entitled “CONTAINER BLANKS AND METHODS OF FORMING THE SAME” and U.S. Provisional Patent Application Ser. No. 60/790,623, filed on Apr. 10, 2006, entitled “BIAXIALLY ORIENTED POLYLACTIC BASED CONTAINERS AND METHODS OF MAKING THE SAME,” the disclosures of these applications are herein incorporated by reference in their entireties.

### BACKGROUND OF THE INVENTION

1. Field of the Invention

The subject invention is directed to containers and packaging, and more particularly, to methods for forming container blanks and packaging from Polylactic Acid (PLA), a biodegradable polymer sheet material.

2. Background of the Related Art

Today plastics are used heavily by the packaging industry. Plastic packaging offers protection against moisture, dirt, safeguards hygiene, and provides an attractive product. There are many different types of petroleum-based plastics used for packaging today, such as polyethylene terephthalate (PET), glycolised polyester (PETG), amorphous polyethylene terephthalate (APET), polyvinyl chloride (PVC), etc. However, the environmental impact of plastic waste is a growing global concern, and alternative disposal methods are limited. Also, because petroleum resources are finite and are becoming limited, the cost of petroleum-based plastic sheet material is on the rise.

The continuously growing concern over the environmental impact caused by petroleum-based plastics has stimulated research interest in biodegradable polymers as alternatives to conventional nondegradable polymers, such as polyethylene and polystyrene etc. Cargill Dow LLC has developed a new plastic material called Polylactic Acid (PLA) which is derived from plant sugars and is produced by its wholly-owned subsidiary, NatureWorks, LLC.

To date, PLA has been used to manufacture extruded plastic containers, cups and bottles, but it has not been used as a substrate for boxes or containers made from a folded blank, due to the brittleness of the material and an inability to create fold lines in the sheet/film material using conventional techniques.

Several techniques are known for creating fold lines in plastic sheet, such as knife-scoring, radio frequency (RF) soft creasing and micro-perforation. One method for producing fold lines in a thermoplastic sheet is described in German patent No. 2,236,617. According to this method, a knife edge is resistance heated to a temperature above the melting temperature of the plastic and the edge is pressed into the plastic sheet.

Contrary to the explanation given in the patent, it has been found that a spring back resilience in the folded edges cannot be avoided to the degree desired. This is apparently due to the fact that the highest temperature is found along the contact surface between the knife edge and the plastic. From there, the temperature decreases towards the inside of the plastic material.

Another technique for creasing polymer substrates is disclosed in U.S. Pat. No. 5,741,570 to Seufert, which is herein incorporated by reference in its entirety. The Seufert patent discloses a mechanical creasing procedure that creates fold lines in the material using groove-like depressions of alternating depth.

Soft-creasing of plastic substrates for packaging applications is desirable because it results in a package corner or hinge that can be folded multiple times without breaking, and does not whiten as a result of repeated bending, as would hard-creased polyvinyl chloride (PVC). A soft-crease can be defined by the score bend ratio, which is a measure of the bending stiffness that can be quantified as the force required to bend a scored substrate to a 90° angle at the score, divided by the force required to bend the same unscored substrate to 90°. A soft-crease typically has a score bend ratio of about 0.2 to about 0.4.

U.S. Pat. No. 4,348,449 to Seufert, which is incorporated herein by reference in its entirety, discloses a technique for soft creasing thermoplastic sheet which will not cause any inconvenient spring back resilience in the folded boxes during their unfolding. The disclosed technique utilizes a fold line or edge forming tool which is kept at a temperature below the melting temperature of the thermoplastic sheet. A high frequency electric field is established between the edge forming tool and an anvil or counter tool as the edge forming tool is pressed into the thermoplastic sheet to a depth of preferably at least 25% of the material thickness. The thermoplastic sheet is then allowed to cool before it is bent or folded.

Therefore, there is a need for container blanks and packaging made from a biodegradable alternative to traditional petroleum-based plastics, such as PLA. Moreover, there is also a need for an economical method for manufacturing container blanks made from biodegradable materials.

### SUMMARY OF THE INVENTION

The present disclosure is directed to a process for forming a container blank with flexible fold lines from polylactic acid sheet material. In the disclosed process, a sheet of polylactic acid material suitable for use as a container blank is placed between a forming tool and a substantially flat surface. The temperature of the forming tool is maintained at a point between the softening temperature and the melting temperature of the polylactic acid sheet. Then, a high frequency electric field is created between the forming tool and the flat surface so as to heat a portion of the polylactic acid sheet sandwiched therebetween, while pressing the forming tool into the sheet to a depth of at least 25% of the thickness of the sheet and forming bulges in the sheet adjacent to opposite sides of the tool. Next, the polylactic acid sheet is allowed to cool while maintaining the same in a substantially flat condition. Thereafter, a container is formed using the creased polylactic acid sheet.

The present disclosure is also directed to a method of forming a container from PLA sheet material. It is presently preferred that the PLA material is biaxially oriented. In the disclosed method, a container blank made of PLA material is dimensioned, cut and scored to form a container blank with a plurality of flaps, a plurality of panels, and a plurality of fold lines. Then an adhesive is applied to a first portion of the container blank and the container blank is folded so that the first portion of said container blank is secured to a second portion of the container blank by the adhesive to form a container with at least one open end. The PLA container blank is scored using an RF soft creasing procedure, which is described in detail hereinbelow.

It is presently preferred that the biaxially-oriented polylactic acid material has been annealed at a temperature of between about 110 degrees Celsius and 130 degrees Celsius. Additionally, in certain preferred embodiments the biaxially oriented polylactic acid material has been stretched in the machine direction to a ratio of between about 1.5 and about 5 and in the cross direction to a ratio between about 1.5 and about 5.

The present disclosure is also directed to a container blank that includes a biaxially oriented polylactic acid paper substrate wherein said substrate has been formed by calendaring or extrusion and is dimensioned, cut and scored to form a container blank with a plurality of flaps, a plurality of panels, and a plurality of fold lines.

The method of the present invention is not limited to the preparation of folded box blanks but may also be used in the production of various other folded wrapping materials, the production of boxes with folded bottoms or tops and other similar articles. In addition, the particular plastic material is not critical as long as the necessary physical properties such as resistance to impact and a melting temperature within a practical range are met.

The present invention meets the aforementioned needs, by providing, among other things, a method for making packaging from a biodegradable alternative to petroleum-based plastics.

### BRIEF DESCRIPTION OF THE DRAWINGS

So that those having ordinary skill in the art to which the disclosed invention appertains will more readily understand how to make and use the same, reference may be had to the drawings wherein:

FIG. 1 is a plan view of a container blank made from PLA plastic sheet material having a plurality of score lines formed by RF soft-creasing;

FIG. 2 is perspective view of the front of a partially assembled container/carton made from the container blank of FIG. 1;

FIG. 3 is a perspective view of the rear of a partially assembled container/carton made from the container blank of FIG. 1, wherein an end flap of the blank is adhered to the rear panel of the container;

FIG. 4 is perspective view of the front of a fully assembled container/carton made from the container blank of FIG. 1; and

FIG. 5 is a perspective view of a representative device for forming fold lines in a sheet of PLA material using RF energy.

These and other features of the container blank of the present invention will become more readily apparent to those having ordinary skill in the art from the following detailed description of preferred embodiments

### DETAILED DESCRIPTION OF PREFERRED EMBODIMENTS

Reference is now made to the accompanying figures for the purpose of describing, in detail, preferred and exemplary embodiments of the present disclosure. The figures and accompanying detailed description are provided to describe and illustrate exemplary manners in which the disclosed subject matter may be made and used, and are not intended to limit the scope thereof.

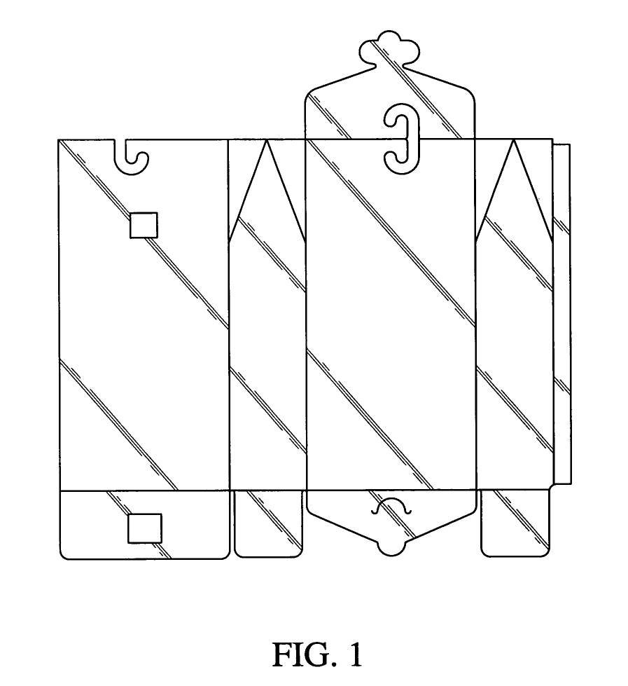

Referring now to FIGS. 1-4 which illustrate an exemplary container blank 100 according to the present invention. Blank 100 has been formed from a single sheet of biaxially-oriented PLA material and has four main panels 10, 12, 14, 16. A glue flap 18 is shown secured to a panel 16. Also illustrated are fold lines 40 that separate the main panels 10, 12, 14, 16 from each other and the remainder of the blank 100. Main panels 12 and 16 also include secondary fold lines 42.

Flaps 20, 22, 24, 26 are shown secured to one end of the main panels 10, 12, 14, 16 respectively and flap 34 is shown secured to main panel 14 (opposite of flap 24). It is to be understood that many other shapes and configurations for a container blank are possible. For example, a container could have more of less main panels, as well as, more or less flaps than illustrated.

The container blank 100 of FIGS. 1-4 is provided as a general illustration of a container blank. It is to further be understood that a container blank could also be designed to mate with a blister container or a packaging shell. Still further, a container blank could also be designed to wrap around another box, container, package, or product. In addition, the container blank could have one of more apertures. For example, the container could also have a folding flap to secure a blister package containing disposable razors or pills. Furthermore, any apertures could be covered with transparent materials.

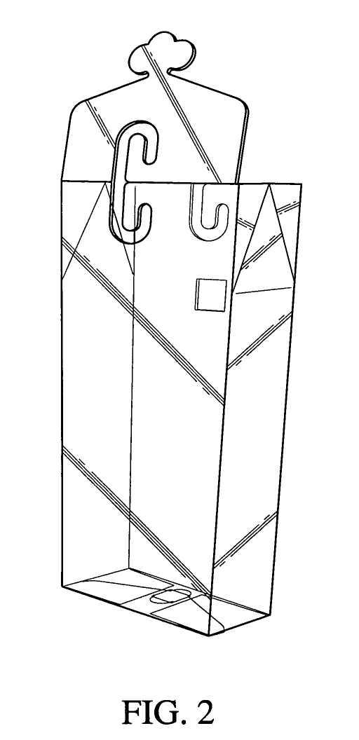

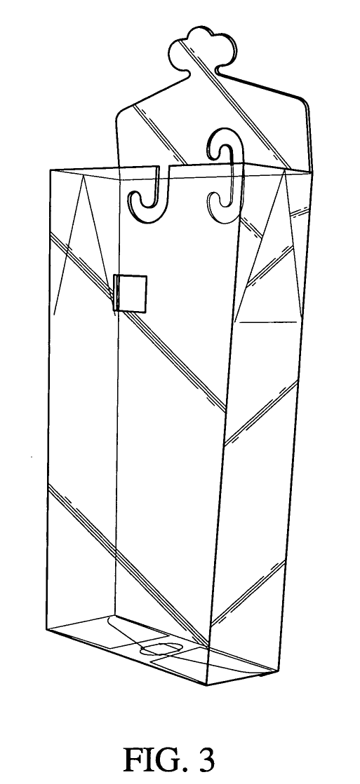

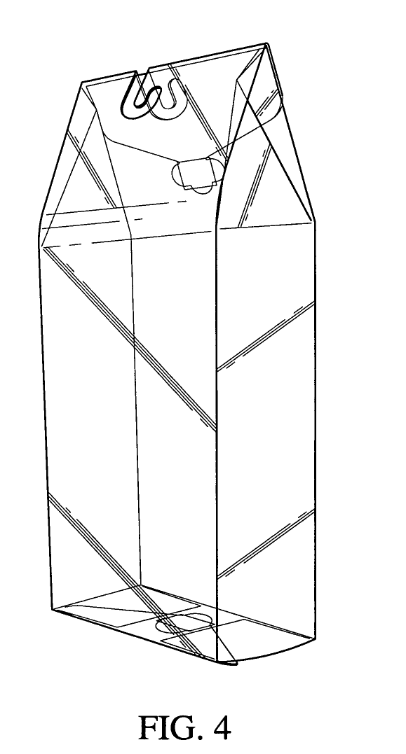

FIGS. 2 and 3 illustrate container blank 100 folded into a container having an open end positioned near its top. FIG. 4 illustrates a fully assembled container made using blank 100.

Manufacturing methods typically used for polymer film substrates, such as PLA, are melt blowing, melt casting, and uniaxially or biaxially stretching (orienting) the polymers. Blown and cast films have low levels of molecular orientation in the polymer and, therefore, are relatively weak in tension and are very extensible but with excellent tear and impact resistance. The inventors of the present application have learned through experimentation that the presently available cast extruded PLA sheet material does not have the physical and thermal stability needed for use as a carton blank.

Biaxially orienting PLA or “stretching” imparts unique characteristics to material and the resulting film is significantly decreased in thickness. As a result of the stretching, the molecular orientation is increased significantly, and the physical properties are enhanced dramatically. The tensile strength and stiffness are increased dramatically in both directions, while the elongation, tear resistance, and gas and moisture permeability are reduced.

Typical material and application properties for biaxially-oriented PLA (3.5× in Machine Direction and 5× in Travel Direction) are provided in Table I.

TABLE I
TYPICAL MATERIAL & APPLICATION
PROPERTIES FOR PLA

| | | | | ASTM |
|---|---|---|---|---|
| Film Properties | | Value | | Method |
| Density | | 1.25 | g/cc | D1505 |
| Tensile Strength MD | | 16 | kpsi | D882 |
| | TD | 21 | kpsi | D882 |
| Tensile Modulus MD | | 480 | kpsi | D882 |
| | TD | 560 | kpsi | D882 |

| | | | |
|---|---|---|---|
| Optical | Haze | 2.1% | D1003 |
| Characteristics | Gloss, 20° | 90 | D1003 |
| Thermal Charteristics | Glass | 126° F. (52° ^{C.}) | D3418 |
| | Transition Temp. | | |
| | Melting Point | 275° F. (135° C.) | D1003 |

Biaxially orienting the PLA material creates a substrate that has the final properties necessary for use in carton manufacture. Preferably, the PLA sheet has been stretched to a ratio of 1.5 to 5 in the machine direction and to a ratio of 1.5 to 5 in the cross direction or travel direction and annealed during the biaxially stretching process. The annealing should be preformed in the range of 110 degrees Celsius and 130 degrees Celsius. Biaxially orienting the PLA material at the above-identified ratios and annealing temperatures allows the film to be printed, cut and creased (using RF softcreasing, microperforation or other mechanical techniques) without severe distortion or degradation of the material. Biaxially orienting the material results in increased dimensional stability which leads to better directional strengths. Moreover, by biaxially orienting the PLA substrate, a 0.010″ sheet of PLA has the same stiffness as PVC or APET two caliper points heavier. (i.e., 0.010″ PLA substitutes for 0.012″ PVC or APET).

As noted above, the biaxially oriented PLA material is creased using RF soft creasing. Although, it is known to soft-crease PVC material, other petroleum-based plastics, such as APET and polypropylene do not crease well using RF creasing techniques. The inventors of the present application have learned that PVC will soft-crease well because it is a relatively polar molecule with a dielectric constant in the range of about 4 to about 8. A higher dielectric constant indicates greater polarity and greater ability to absorb RF energy. RF energy heats the substrate to a softening point in the area of the score or crease, and resolidification of the material results in a durable refoldable hinge or corner thereafter. The dielectric constant for APET is significantly lower (e.g., about 2.5 to about 4.5) than PVC and consequently it is not readily soft-creased by application of RF. PLA however, has a dielectric constant of about 1.0, and contrary to expectation, has been readily creased using RF techniques by the inventors of the present application.

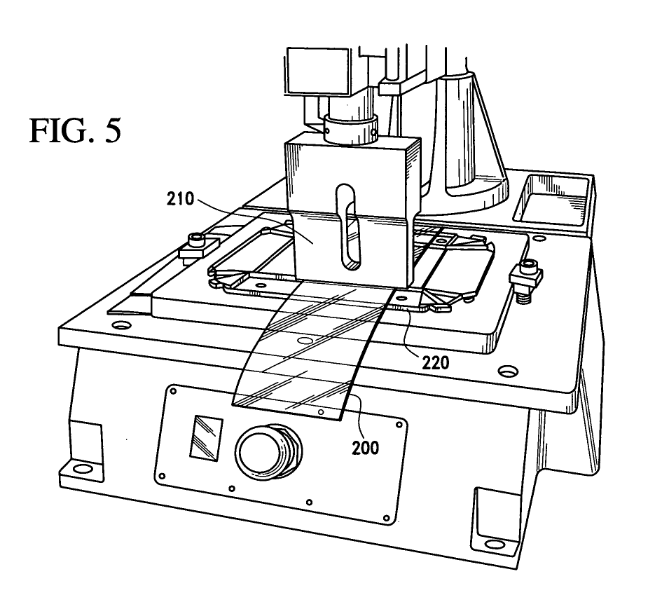

FIG. 5 provides a perspective view of a representative device for forming fold lines in a sheet of PLA material using RF energy. In the forming process, a sheet of polylactic acid material 200 which is suitable for use as a container blank is placed between a forming tool 210 and a substantially flat surface 220. The temperature of the forming tool 210 is maintained at a point between the softening temperature and the melting temperature of the polylactic acid sheet 200. Then, a high frequency electric field is created between the forming tool 210 and the flat surface 200 so as to heat a portion of the polylactic acid sheet sandwiched therebetween, while pressing the forming tool into the sheet to a depth of at least 25% of the thickness of the sheet and forming bulges in the sheet adjacent to opposite sides of the tool. Next, the polylactic acid sheet 100 is allowed to cool while maintaining the same in a substantially flat condition. Thereafter, a container is formed using the creased polylactic acid sheet.

As noted above, in the present method, the temperature of the edge forming tool used in the RF soft creasing process is be kept below the melting temperature of the biaxially oriented PLA sheet. Moreover, the present inventors have learned through experimentation that it is preferable to use an edge forming tool made from aluminum. The use of aluminum allows for a better distribution of the RF energy into the PLA material, in comparison to conventional edge forming tools made from a composite material (e.g., a polyfabric).

The melting temperature of the biodegradable plastic sheet can be taken from the tables and/or processing instructions of the plastic manufacturer. As the '449 patent notes, it also possible to perform the process of the present invention with a cold edge forming tool, i.e. the surface of the tool being kept at room temperature. For best results, the temperature of the edge forming tool is kept above the softening temperature of the thermoplastic sheet. A temperature between the softening and melting temperatures of the plastic is most advantageous since this promotes the oscillation of the plastic molecules necessary for the development of heat. It is important that the temperature gradient not start from the surface of the edge forming tool but rather that the highest temperature be produced inside the material. This is accomplished by the use of a high frequency electric field which, in combination with the depth of impression of the edge forming tool results in a characteristic fold line cross-section which will be described in detail hereinafter.

By using a high frequency electric field for heating, the outer surface of the PLA plastic sheet preserves its consistency. In addition, only a narrow strip of the inner part of the plastic material is melted and when the surfaces are pressed together by the edge forming tool the melted plastic moves slightly sideways forming a bulge which gives the fold line its characteristic cross section and characteristic bending behavior.

The fold lines produced using RF soft-creasing make it possible to make box blanks out of biaxially oriented PLA polymer sheets which can be set up in the same manner as cardboard boxes. The box blanks do not exhibit any spring back resilience and therefore they can be processed on standard cardboard and packing machines thus making it possible to process cardboard and thermoplastic boxes alternately. This advantage is significant since it does not require large expenditures for the manufacture or purchase of new equipment.

In the preferred embodiment of the invention, the frequency of the electric field is 27.5 MHz according to the regulations of the German Federal Postal Service. The use of RF induced dies at 27.5 Mhz in contact with the PLA film actively vibrates the polar —OH and —COOH groups which make up the PLA.

It is, however, possible to increase the frequency up to 80 or 90 MHz. With certain materials, the higher the frequency, the faster the process. At the given frequency of 27.5 MHz, the high-frequency impression requires approximately one second and the subsequent cooling requires approximately another second. Thus, the fold lines are produced in approximately two seconds.

What is claimed is:

1. A process for forming a container blank having flexible fold lines from polylactic acid sheet material comprising:
a) providing a sheet of polylactic acid suitable for use as a container blank;
b) providing at least one forming tool and a substantially flat surface;
c) placing the polylactic acid sheet between the forming tool and the flat surface;
d) maintaining the temperature of the forming tool at a point between the softening temperature and the melting temperature of the polylactic acid sheet;
e) creating a high frequency electric field between the forming tool and the flat surface to heat the polylactic acid sheet therebetween while pressing the forming tool into the sheet to a depth of at least 25% of the thickness of the sheet and forming bulges in the sheet adjacent to opposite sides of the tool;
f) allowing the polylactic acid sheet to cool while maintaining the same in a substantially flat condition; and
g) thereafter forming a folded container from the sheet.

2. A process as recited in claim 1, wherein the at least one forming tool is made from aluminum.

3. A process as recited in claim 1, wherein the sheet of polylactic acid is biaxially oriented.

4. A process as recited in claim 3, wherein the sheet of biaxially oriented polylactic acid has been annealed at a temperature of between about 110 degrees Celsius and 130 degrees Celsius.

5. A process as recited in claim 3, wherein the biaxially oriented polylactic acid sheet has been stretched in the machine direction to a ratio of between about 1.5 and about 5 and in the cross direction between about 1.5 and about 5.

6. A method of forming a container from polylactic acid sheet material comprising the steps of:
a) providing a container blank made of polylactic acid material wherein said polylactic acid material is dimensioned, cut and scored to form a container blank with a plurality of flaps, a plurality of panels, and a plurality of fold lines;
b) applying an adhesive to a first portion of said container blank; and
c) folding said container blank so that the first portion of said container blank is secured to a second portion of said container blank by said adhesive to form a container with at least one open end, wherein the first and second portions are integrally associated portions of the container blank.

7. A method as recited in claim 6, wherein the container blank is made of biaxially oriented polylactic acid.

8. A method as recited in claim 7, wherein the container blank is scored using an RF soft creasing procedure which includes that steps of:
a) providing at least one forming tool and a substantially flat surface;
b) placing the biaxially oriented polylactic acid material between the forming tool and the flat surface;
c) maintaining the temperature of the forming tool at a point between the softening temperature and the melting temperature of the biaxially oriented polylactic acid material;
d) creating a high frequency electric field between the forming tool and the flat surface to heat the biaxially oriented polylactic acid material therebetween while pressing the forming tool into the material to a depth of at least 25% of the thickness of the material and forming bulges in the material adjacent to opposite sides of the tool;
e) allowing the biaxially oriented polylactic acid material to cool while maintaining the same in a substantially flat condition; and
f) thereafter forming a folded container from the sheet.

9. The method as recited in claim 7, wherein the biaxially oriented polylactic acid material has been annealed at a temperature of between about 110 degrees Celsius and 130 degrees Celsius.

10. The method as recited in claim 7, wherein the biaxially oriented polylactic acid material has been stretched in the machine direction to a ratio of between about 1.5 and about 5 and in the cross direction between about 1.5 and about 5.

11. The method as recited in claim 8, wherein the at least one forming tool is made from aluminum.

12. A container blank comprising a biaxially oriented polylactic acid paper substrate wherein said substrate has been formed by calendaring or extrusion and is dimensioned, cut and scored to form a container blank with a plurality of flaps, a plurality of panels, and a plurality of fold lines.

13. A container blank comprising: a synthetic paper substrate formed from single D- or L-isomers of lactic acid or mixtures thereof, wherein said substrate has been calendered and is dimensioned, cut and scored to form a container blank having a plurality of flaps, a plurality of panels, and a plurality of fold lines.
